(19) United States
(12) Patent Application Publication
(10) Pub. No.: US 2011/0233471 A1
(43) Pub. Date: Sep. 29, 2011

(54) METHOD AND SYSTEM FOR SUPPLYING A REACTOR FOR GENERATING CRUDE SYNTHESIS GAS

(75) Inventors: Stefan Hamel, Wenden (DE); Johannes Kowoll, Bochum (DE)

(73) Assignee: UHDE GMBH, DORTMUND (DE)

(21) Appl. No.: 12/998,834

(22) PCT Filed: Nov. 20, 2009
(86) PCT No.: PCT/EP2009/008267

§ 371 Date: Jun. 8, 2011

(30) Foreign Application Priority Data
Dec. 9, 2008 (DE) 10 2008 060 893.9

(51) Int. Cl. C10L 3/10; B01J 19/00

(52) U.S. Cl. 252/373; 422/129; 422/198; 422/187; 422/234

(57) ABSTRACT

Using a method for supplying a reactor (32) for generating crude synthesis gas with fuel (3), the fuel supply of a pressurized gasification system according to the line is to be configured in such a manner that the introduction of nitrogen into the crude gas is minimized or completely avoided. This is achieved in that—for inertization and loosening of the fuel in the storage container (2), —for loosening and fluidization of the content of the lock containers (5), —as the lock gas from the lock containers (5), —for loosening and fluidization in the feed container (29), as well as—for feed of the fuel between the system parts and out of the feed container (29) to the gasification reactor (32), a gas consisting predominantly of CO₂ (more than 95 vol.-% CO₂ with admixtures such as H₂, CO, N₂, hydrocarbons or the like) is used.

The invention is directed at a method as well as a system for supplying a reactor for generating crude synthesis gas from fine-grain to dust-type fuels.

Supplying such gasification systems with corresponding fuels is known in different embodiments; for example, an application of the applicant, which was not a prior publication, DE 10 2008 050 075, concerns itself with a feed device that ensures increased system availability, whereby there, the particular special type of conveying, i.e. the special configuration of the conveying paths and the conveying technology, only plays a marginal role.

Conveying systems with a mixture of one and two CO₂ gas or by means of pure CO₂ are known from the unexamined published patent applications 10 2007 020 332 A and 10 2007 020 332 A, respectively, whereby in the one case, a second gas has to be made available, namely N₂, while in the other case, pure CO₂ has the disadvantage that temperatures above the border to the two-phase region must always be maintained. Conveying by means of CO₂ gas is also known from WO 2008/025556 A, for example.

Other disadvantages of the known solution consist, for example, in that when there is a reasonable length of the heated pipelines that are used for the use of pure CO₂, between the lock containers and the required relaxation, heating is then so low that it is not possible to reliably avoid the two-phase state of the CO₂. In this connection, relaxation of the multi-stage relaxation device must take place, in order to avoid polytropic cooling of the gas, which contains dust, to below the dew point.

More problematic than the two-phase state of CO₂ is the water ice formation from the moisture that diffused into the lock gas from the solid, in the lock container. Particularly low temperatures, for example clearly below 0° C., occur in the end phase of relaxation, whereby water ice can be formed.

Lock passage under pressure, which is based on gravity flow, is particularly problematic, and has proven to be insufficiently operationally reliable. Despite many extremely varied approaches, it has proven to be extraordinarily difficult to carry out the process of container pressurization in such a gentle manner that internal tensions in the bulk material can be kept sufficiently low. In many cases, the bulk material is compacted locally, to such an extent that subsequently, gravity flow to the feed container does not occur, or occurs only to an insufficient degree. Furthermore, lock systems based on gravity flow are frequently complicated and must be designed with a large construction height, since it is necessary to design containers between which conveying is to take place so that they are situated one on top of the other.

It is also known in gasification systems the loosening and fluidization required for transport of solids, the pressurization of the lock container, and the transport and metering under pressure is carried out with nitrogen, which is available, to a sufficient degree, from the air separation system. The use of nitrogen has proven itself and has been matured to the greatest possible extent. If the goal of the gasification system is producing a synthesis gas for subsequently carrying out different chemical syntheses, then the nitrogen component in the synthesis gas is extremely undesirable and furthermore generally restricted to limit values that depend on the synthesis, in each instance.

The task of the present invention consists in configuring the fuel supply of a pressurized gasification system according to the line in such a manner that the introduction of nitrogen into the crude gas is minimized or completely avoided, in order to correspondingly reduce the disadvantages connected with this.

This task is accomplished, according to the invention, with a method of the type indicated initially, in that
for inertization and loosening of the fuel in the storage container,
for loosening and fluidization of the content of the lock containers,
as the lock gas from the lock containers,
for loosening and fluidization in the feed container, as well as
for feed of the fuel between the system parts and out of the feed container to the gasification reactor, a gas consisting, predominantly of CO₂ (more than 95 vol.-% CO₂ with admixtures such as H₂, CO, N₂, hydrocarbons or the like) is used.

To accomplish the corresponding task, the invention also provides for a system that is characterized in that feeds of gas consisting predominantly of CO₂ are provided, namely
lines for inertization and loosening of the fuel in the storage container by means of the CO₂ gas,
lines for feeding the CO₂ gas in for loosening and fluidization of the content of the lock containers as well as for making it available as a lock gas,
a line for feeding the CO₂ gas in for loosening and fluidization in the feed container, as well as
a line for feeding the CO₂ gas in as a transport gas from the feed container to the gasification reactor.

Further embodiments of the invention are evident from the dependent claims.

The method of effect of the method according to the invention and of the system according to the invention will be explained in greater detail below, using the single FIGURE, which shows a simplified system diagram.

In the system, designated in general with 1, the dust-type fuel 3 is temporarily stored in a storage container 2, and from there transferred to the lock containers 5 by way of a connection line 4. In order to be able to take fuel out of the storage container 2, the pressure of the lock containers 5 must first be reduced to the pressure level of the storage container. The gas 6 that flows out of the lock containers is first heated 7, then the dust is removed 8, and only afterwards is it relaxed. During relaxation of the lock, the gas is clearly cooled because of the isotropic or polytropic relaxation, and therefore ice formation from the water vapor that comes from the residual moisture of the coal and condensation of CO₂ can disrupt the process. Furthermore, the lock container is cyclically confronted with low temperatures, causing the container wall to be subjected to mechanical stress, which leads to fatigue of the material in the case of a cyclical process. In order to avoid this, the lock container is heated from the outside, electrically or with a medium.

In contrast, the heated gas can be cleaned of dust and relaxed further without difficulties. Under elevated pressure, the heat exchange is very intensive, so that a relatively small heat exchanger is sufficient. First, an MP buffer container 10 is filled to a medium pressure level (MP) with the heated and de-dusted gas 9; in the next relaxation step, an LP buffer container 11 is filled at a lower pressure level, and the rest of the gas is relaxed 12 and usually released into the atmosphere, either directly or by way of the filter with which the solids content of the gas can be further reduced. The gas from the LP buffer container 11 is used for inertization 15 and fluidization 16 of the storage container. Optionally, a part of the gas 17 can also be used for other applications at a lower pressure level, such as for inertization of the grinding system, for example. The gas stored in the MP buffer container 10 is used here for partial pressurization of the lock containers 20; the rest can advantageously be used, for example, for treatment of the flue ash precipitated out of the crude gas, thereby making it possible to further clearly reduce the inert gas demand and the CO₂ emission into the atmosphere.

After the lock container 5 has taken up the fuel at a low pressure level, partial pressurization with MP recycled gas 20 takes place. The pressure level required for lock passage is achieved by means of further feed of gas 22 consisting predominantly of carbon dioxide. Only afterwards does conveying of the dust-type fuel from the lock container 5 into the feed container 29 take place. For this purpose, loosening and fluidization gas 23 is added, so that the fuel conveyed to the re-conveying line 28 by way of a connection line 26 and a combining element 27, and from there to the feed container 29, with the additional application of transport gas 24, by means of dense current conveying. The lock containers 5 are used for conveying the fuel with time offset, so that a quasi-continuous supply of the feed container 29 occurs. The transport gas introduced into the feed container with the fuel is removed 36 from the feed container, the dust is removed from it in the filter 13, for example, and it is released to the atmosphere together with the other relaxation gases.

It is also possible to remove the dust from the gas 36 in a filter that works under pressure, and to pass it to the buffer containers. In order to maintain the pressure of the feed container 29, it can be necessary to add 25 a gas, for example for the short term during switching of the lock containers 5, or during the startup process of the system.

The feed container 29 is permanently at operating pressure and continuously supplies 30 the burners 31 of the gasification reactor 32. Conveying out of the feed container takes place by means of adding loosening and fluidization gas 37 and adding further transport gas 38 into the burner line 30.

Since the gas 21, which consists predominantly of carbon dioxide, is generally obtained, in gasification systems, from the gas scrubbing system that follows, the use of nitrogen is provided for startup operation of the system as a whole, and this nitrogen can simply be kept on hand for this purpose. As soon as operation has started to such an extent that the carbon dioxide is separated in the gas purification system, a switch to gas that contains carbon dioxide is made for further normal operation.

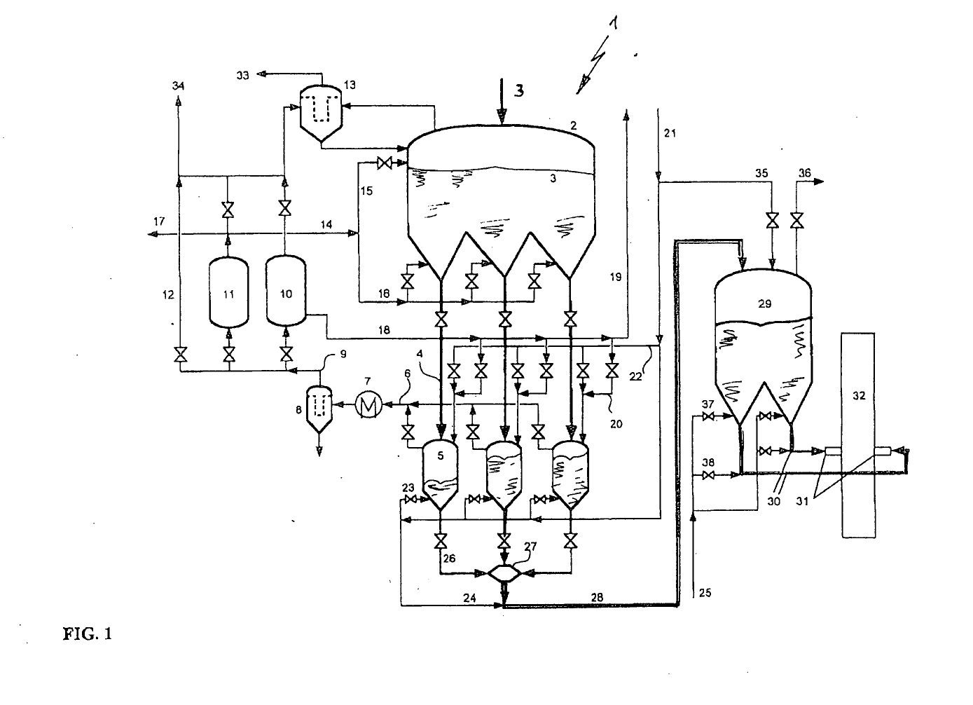

The gas that contains carbon dioxide and is obtained in the gas purification system generally contains small amounts of components such as carbon monoxide, hydrogen sulfide, hydrocarbons, etc., for example. Since parts of the gas used for lock passage are released to the atmosphere, in the exemplary embodiment in FIG. 1 the streams 33, 34, possibly 36, prior purification of the gas that contains carbon dioxide is necessary, so that the permissible emission limit values are not exceeded.

The gas obtained in a gas purification system based on a solvent (methanol, MDEa, and others) contains, aside from the main component CO₂, the following volume proportions of other components, for example: CO<1%, H₂<1%, N<1%, and traces of methane, hydrogen sulfide, argon, and the solvent used. If a cryogenic liquid nitrogen wash is used for gas purification, the nitrogen proportion is clearly higher, for example 15% by volume.

The high CO content is harmful to the environment. In order to limit the amount of CO released, it is advantageous to expand the gas purification system to include additional separation columns, and to separate the contaminated CO₂ into two fractions. One fraction having a low CO content, for example <100 ppmv, is used for lock passage, and afterwards released, and the other fraction, having a high CO content, is either treated or recirculated.

The advantageous embodiment of the invention in FIG. 1 shows a separation between the gas that contains carbon dioxide, which is used 21 for lock passage, for lock container pressurization, for solids transport from the lock container to the feed container, and for maintaining the pressure in the feed container, and the gas that contains carbon dioxide, which is used 25 for conveying fuel to the burners. For the gas stream 21, the purification indicated above with regard to the emission limit values is required, since the major portion of the gas is emitted to the atmosphere. However, even unpurified gas can be used for loosening and fluidization 37 and for the transport gas 38, since it gets into the gasifier with the fuel, by way of the burners, and participates in the reactions that take place there, at high temperatures.

In FIG. 1, an advantageous embodiment of the invention is shown as an example. Further advantageous variations are possible, such as, for example, the use of only one buffer container. This can be advantageous if other consumers no longer need any MP recycled gas 19, for example if no flue ash treatment has to be provided due to the configuration of the gasification reactor.

The embodiment of the storage container 2, the lock containers 5, and the re-conveying line 28 shown in FIG. 1 is an example that is used here to illustrate the basic sequences. It is provided that the number of lock containers can be greater. Also, it is provided that the lock containers supply the feed container 29 by way of multiple re-conveying lines.

### REFERENCE SYMBOL LIST

1 system
2 storage container
3 fuels
4 connection line
5 lock container(s)
6 gas to be relaxed
7 heat exchanger
8 filter
9 heated gas, cleaned of dust, to be relaxed
10 MP buffer container
11 LP buffer container
12 relaxation gas
13 filter
14 LP recycled gas
15 LP recycled gas for inertization
16 LP recycled gas for loosening and fluidization
17 LP recycled gas to consumers
18 MP recycled gas
19 MP recycled gas to consumers
20 MP recycled gas to the lock containers
21 gas
22 pressurization gas
23 gas for loosening and fluidization
24 transport gas
25 gas for loosening and fluidization
26 connection line
27 combining element
28 re-conveying line
29 feed container
30 burner lines
31 burner
32 gasification reactor
33 gas to the atmosphere
34 gas to the atmosphere
35 gas
36 gas
37 gas for loosening and fluidization
38 transport gas

1. Method for supplying a reactor (32) for generating crude synthesis gas with fuel (3) from a storage container (2), with the interposition of lock containers (5) and at least one feed container (29),
wherein
for inertization and loosening of the fuel in the storage container (2),
for loosening and fluidization of the content of the lock containers (5),
as the lock gas from the lock containers (5),
for loosening and fluidization in the feed container (29), as well as
for feed of the fuel between the system parts and out of the feed container (29) to the gasification reactor (32), a gas consisting predominantly of CO₂ (more than 95 vol.-% CO₂ with admixtures such as H₂, CO, N₂, hydrocarbons or the like) is used.

2. Method according to claim 1, wherein
the gas conducted away by means of lowering the pressure level of the lock container (5), in each instance, to the pressure level of the storage container (2), is passed by way of a heat exchanger (7).

3. Method according to claim 2, wherein
the gas that leaves the heat exchanger (7) is passed by way of a filter (8).

4. Method according to claim 2, wherein
the heated and de-dusted CO₂ gas is passed to an MP (medium pressure) buffer container and brought to the desired medium pressure level there.

5. Method according to claim 2, wherein
the heated and de-dusted CO₂ gas is passed to an LP (low pressure) buffer container (11) and brought to the desired low pressure level there.

6. Method according to claim 2, wherein
the heated and de-dusted CO₂ gas is relaxed to atmospheric pressure by way of a de-gasification line (12).

7. Method according to claim 1, wherein
the gas streams from the MP buffer container (10) and/or from the LP buffer container (11) and/or the relaxation line (12), after relaxation to atmospheric pressure, is passed to the atmosphere, directly or by way of a filter (13).

8. Method according to claim 1, wherein
the filter (6) and/or the filter (13) is/are cleaned by means of the gas that consists predominantly of CO₂.

9. Method according to claim 1, wherein
at least a part of the gas that leaves the MP buffer container (10) is used for pressurizing the lock containers (20).

10. Method according to claim 1, wherein
a part of the gas that leaves the MP buffer container (10) is used for treatment of the flue ash precipitated out of the crude gas.

11. Method according to claim 1, wherein
the feed of the fuel out of the lock container (5) into the feed container is undertaken by means of dense current feed.

12. Method according to claim 1, wherein
a gas having a higher CO content than the permissible CO content of the released gases is used for transport gas (38) and fluidization (37).

13. System for conveying a carbonaceous fuel (3) from a storage container (2) to a gasification reactor (32), by way of lock containers (5) as well as by way of a feed container (29), for carrying out the method according to claim 1, comprising
feeds (16, 23, 37, 38) of gas consisting predominantly of CO₂, namely
lines (16) for inertization and loosening of the fuel in the storage container (2) by means of the CO₂ gas,
lines (23) for feeding the CO₂ gas in for loosening and fluidization of the content of the lock containers (5) as well as for making it available as a lock gas,
a line (37) for feeding the CO₂ gas in for loosening and fluidization in the feed container (29), as well as
a line (38) for feeding the CO₂ gas in as a transport gas from the feed container (29) to the gasification reactor (32).

14. System according to claim 13, wherein
the lock container(s) (5) is/are provided with a heating device.

15. System according to claim 14, wherein
a heat exchanger (7) is provided for heating the gas that comes from the lock containers (5).

16. System according to claim 15, wherein
at least one pressure-resistant dust filter (8) is provided for removing dust from the gas that leaves the heat exchanger (7).

17. System according to claim 16, wherein
an MP (medium pressure) buffer container and/or an LP (low pressure) buffer container and/or a relaxation gas line (12) follow(s) the heat exchanger (7) and/or the dust filter (8).

18. System according to claim 13, wherein
a feed line (20) for MP recycled gas from the MP buffer container (10) to the lock containers (5) is provided.
